(19) United States
(12) Patent Application Publication
(10) Pub. No.: US 2014/0347436 A1
(43) Pub. Date: Nov. 27, 2014

(54) PORTABLE TRANSPARENT DISPLAY WITH LIFE-SIZE IMAGE FOR TELECONFERENCE

(71) Applicant: SONY CORPORATION, Tokyo (JP)

(72) Inventors: Marvin DeMerchant, San Diego, CA (US); David Andrew Young, San Diego, CA (US); Steven Friedlander, San Diego, CA (US); David George Thiele, San Diego, CA (US)

(73) Assignee: SONY CORPORATION, Tokyo (JP)

(21) Appl. No.: 13/899,781

(22) Filed: May 22, 2013

(51) Int. Cl. H04N 7/15

(52) U.S. Cl. CPC H04N 7/15
USPC 348/14.08

(57) ABSTRACT

A local teleconference participant can view a near-life-size image of a remote teleconference participant on a thin transparent upright display. Because the display is transparent, local background images that surround the image of the remote participant can be viewed through the display just as they would be if the remote participant were present locally.

### I. FIELD OF THE INVENTION

The present application relates generally to transparent displays with near life-size images for teleconferences.

### II. BACKGROUND OF THE INVENTION

Remote teleconferencing provides a cost effective way to conduct communications with a person while viewing the person. However, as understood herein remote teleconferencing can feel unnatural when using a phone or tablet computer or even a TV, compared to an actual in-person dialog, since there is no feeling the other person is actually in the room.

### SUMMARY OF THE INVENTION

A transparent ultra-thin panel displays a substantially life-size image of a remote participant during a video teleconference. The teleconference can be a telephone conference or an Internet conference. Each participant device can contain a high resolution steerable camera, a microphone array, and an audio system with digital signal processing (for wide field aural effect) to enhance the feeling of being in the same room for all participants. Each participant device can use near field communication (NFC) technology to trigger the transfer of the teleconference video and audio to and from an ultra-portable device such as a smart phone or tablet to the associated ultra thin display. Face recognition and voice tracking may be used to automatically steer the camera to follow user movements.

Accordingly, an assembly includes a processor and a video display configured to be controlled by the processor to present on the video display a demanded image of a person participating in a telephone call. The video display is transparent when no image is presented thereon.

In example embodiments, the demanded image is of a portion of the person participating in the telephone call, and the demanded image is substantially the same size as the portion of the person. The demanded image may be 60%-120% of the size of the portion of the person, more preferably may be 80%-110% of the size of the portion of the person, and more preferably still may be 90%-100% of the size of the portion of the person. Because the display is transparent, local background objects that surround the demanded image can be viewed through the display just as they would be if the person were present locally.

The demanded image can be projected onto the display. The processor may be in a user device having a native display controlled by the processor in addition to the video display that is transparent.

In another aspect, an assembly includes a communication interface receiving video signals from a remote participant of a teleconference. A transparent video display presents demanded images of the remote participant based on the video signals. Local background objects behind the display are visible to a local teleconference participant through the display just as the background objects would be if the remote participant were present locally with the local participant.

In another aspect, a method includes establishing a teleconference link with a remote teleconference participant, receiving demanded images of the remote teleconference participant, and presenting on a transparent video display the demanded images.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a block diagram of an example specific system;

FIG. 3 is a flow chart of example logic;

FIG. 4 is a perspective view of a local teleconference participant viewing the substantially life-size image of a remote teleconference participant on the local transparent display;

FIG. 5 is a perspective view of a writing participant writing on a substrate for transmission of the writing to a reading participant; and

FIG. 6 is a perspective view of a reading participant viewing an image of writing from a writing participant.

### DETAILED DESCRIPTION OF THE PREFERRED EMBODIMENT

Disclosed are methods, apparatus, and systems for computer based user information. A system herein may include server and client components, connected over a network such that data may be exchanged between the client and server components. The client components may include one or more computing devices. These may include personal computers, laptops, tablet computers, and other mobile devices including smart phones. These client devices may operate with a variety of operating environments. For example, some of the client computers may be running Microsoft Windows® operating system. Other client devices may be running one or more derivatives of the Unix operating system, or operating systems produced by Apple® Computer, such as the IOS® operating system, or the Android® operating system, produced by Google®. While examples of client device configurations are provided, these are only examples and are not meant to be limiting. These operating environments may also include one or more browsing programs, such as Microsoft Internet Explorer®, Firefox, Google Chrome®, or one of the other many browser programs known in the art. The browsing programs on the client devices may be used to access web applications hosted by the server components discussed below.

Server components may include one or more computer servers executing instructions that configure the servers to receive and transmit data over the network. For example, in some implementations, the client and server components may be connected over the Internet. In other implementations, the client and server components may be connected over a local intranet, such as an intranet within a school or a school district. In other implementations a virtual private network may be implemented between the client components and the server components. This virtual private network may then also be implemented over the internet or an intranet.

The data produced by the servers may be received by the client devices discussed above. The client devices may also generate network data that is received by the servers. The server components may also include load balancers, firewalls, caches, and proxies, and other network infrastructure known in the art for implementing a reliable and secure web site infrastructure. One or more server components may form an apparatus that implement methods of providing a secure community to one or more members. The methods may be implemented by software instructions executing on processors included in the server components. These methods may utilize one or more of the user interface examples provided below in the appendix.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor such as the AMD® Athlon® II or Phenom® II processor, Intel® i3/i5®/i7® processors, Intel Xeon® processor, or any implementation of an ARM® processor. In addition, the processor may be any conventional special purpose processor, including OMAP processors, Qualcomm® processors such as Snapdragon®, or a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. The description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be written in any conventional programming language such as C#, C, C++, BASIC, Pascal, or Java, and run under a conventional operating system. C#, C, C++, BASIC, Pascal, Java, and FORTRAN are industry standard programming languages for which many commercial compilers can be used to create executable code. The system may also be written using interpreted languages such as Pert Python or Ruby. These are examples only and not intended to be limiting.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a, computer-readable medium. Computer-readable media include both computer storage media and communication media including any medium that facilitates transfer of a computer program from one place to another. However, a computer readable storage medium is not a carrier wave, and may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.) It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting.

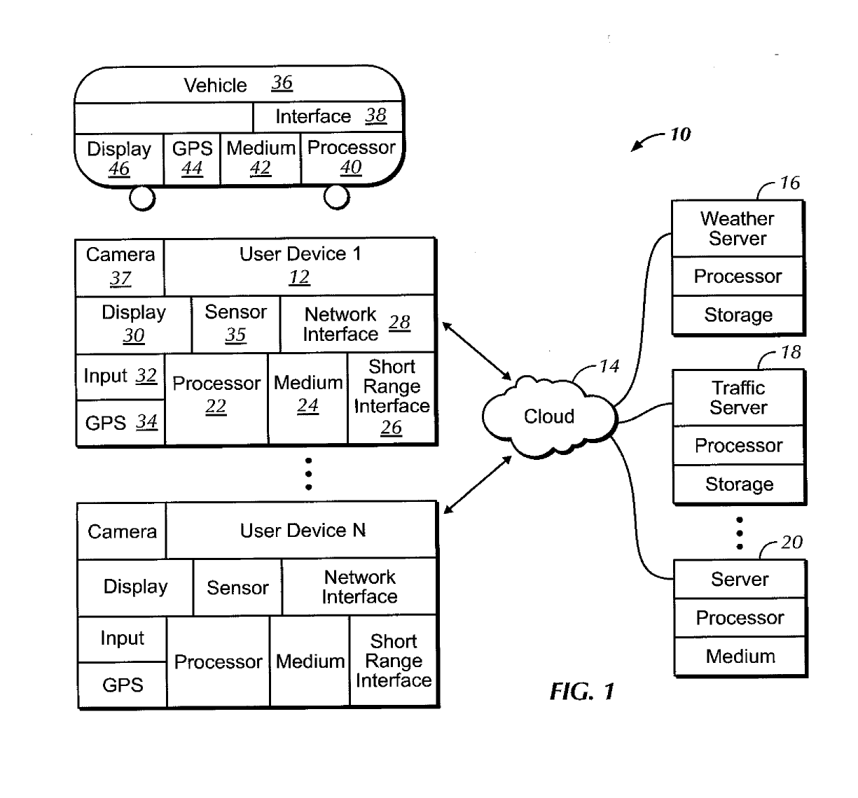

Referring initially to FIG. 1, a system 10 includes at least one and in the example shown “N” user or client devices 12 communicating via a computer cloud 14 such as the Internet with one or more server computers. In the example shown, a weather server 16, a traffic server 18, and in general one or more servers 20 communicate with the client device 12 through the cloud.

Among the non-limiting and example components a client device 12 may incorporate, a processor 22 accesses a computer readable storage medium 24 that contains instructions which when executed by the processor configure the processor to undertake principles disclosed below. The client device 12 may communicate with other client devices using a wireless short range communication interface 26 such as but not limited to a Bluetooth transceiver controlled by the processor 22. Also, the client device 12 may communicate with the cloud 14 using a wireless network interface 28 such as but not limited to one or more of a WiFi transceiver, wireless modern, wireless telephony transceiver, etc. controlled by the processor 22. Wired interfaces 26, 28 are also contemplated.

The client device typically includes a visual display 30 such as a liquid crystal display (LCD) or light emitting diode (LED) display or other type of display controlled by the processor 22 to present demanded images. The display 30 may be a touch screen display. In addition, one or more input devices 32 may be provided for inputting user commands to the processor 22. Example input devices include keypads and keyboards, point-and-click devices, a microphone inputting voice commands to a voice recognition engine executed by the processor 22, etc. A position sensor 34 may input signals to the processor 22 representing a location of the client device 12. While FIG. 1 assumes that the position receiver 34 is a global positioning satellite (GPS) receiver, other position sensors may be used in addition or in lieu of a GPS receiver. For example, a motion sensor 35 such as an accelerometer, gyroscope, magnetic sensor, and the like may be used to input position information to the processor 22. Location information may also be derived from WiFi information, e.g., the location of the client device may be inferred to be the location of a WiFi hotspot in which the device is communicating. Also, a camera 37 may provide image signals to the processor 22.

FIG. 1 also shows that a person carrying the client device 12 may decide to enter a vehicle 36. The vehicle 36 may include a communication interface 38 controlled by a vehicle processor 40 accessing a computer readable storage medium 42. The interface 38 may be configured to communicate with one of the interfaces of the client device 12 and may be a Bluetooth transceiver. The vehicle 36 may include an onboard GPS receiver 44 or other position receiver sending signals to the processor 40 representing the location of the vehicle 36. The vehicle processor 40 may control a visual display 46 in the vehicle to, e.g., present an electronic map thereon and other user interfaces. Other client devices may be transported by their users into other vehicles and establish communication with the processors of the other vehicles.

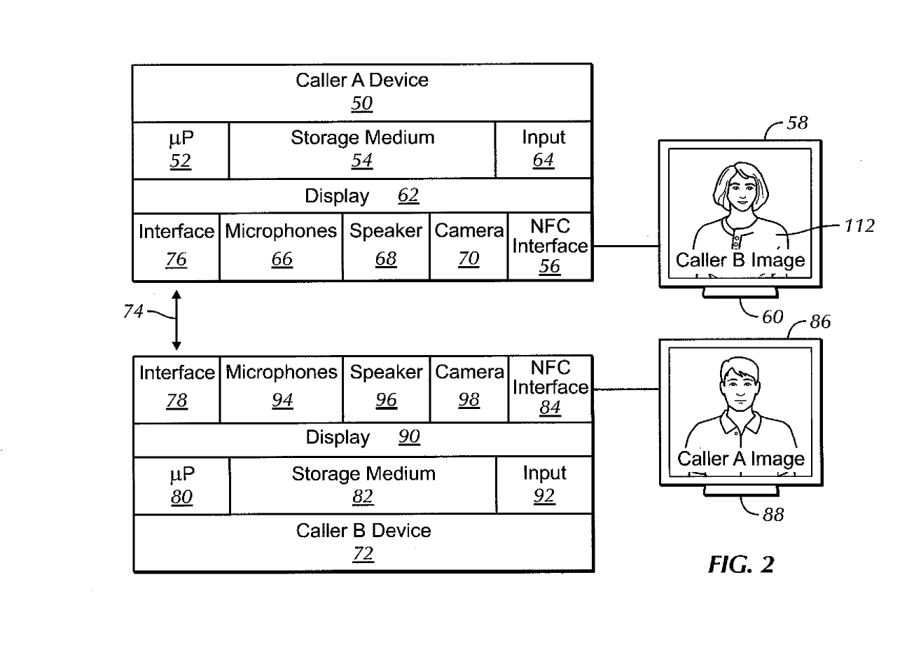

FIG. 2 shows an example specific embodiment to illustrate the teleconferencing principles set forth herein. A first user device 50, labeled “caller A” device, is shown and includes a processor 52 accessing a computer readable storage medium 54 that contains instructions which when executed by the processor configure the processor to undertake principles disclosed below. The user device 50 may communicate with other devices using a near field communication (NFC) interface 56. The NFC interface 56 may be a wireless short range communication interface such as but not limited to a Bluetooth transceiver controlled by the processor 52. Radiofrequency identification (RFID) can also be used, without limitation. Note that NFC pairing between the device and display may be used to trigger video transfer to the display, but the actual video data transfer may occur over a separate link, e.g., Bluetooth, WiFi, or other link. In the example shown, the user device 50 communicates with a relatively large but still portable thin transparent display 58, which in one example has no frame. In an example, demanded images from the user device 50 may be presented on the display 58 by means of a projector 60 of the display 58, which projects images onto the display 58 using, in non-limiting examples, heads-up display principles, such that images may be perceived on the otherwise transparent display 58. In a non-limiting example heads-up display (HUD) principles such as those discussed in U.S. Pat. No. 8,269,652, incorporated herein by reference, may be used. In some examples using HUD principles, a coating may be deposited onto the transparent display, and the coating reflects monochromatic light projected onto it from the projector while allowing other wavelengths of light to pass through. Without limitation, HUD displays that may be used include a solid state light source, for example a light emitting diode which is modulated by a liquid crystal display screen to display an image. Optical waveguides may be used in lieu of a projector, or a scanning laser can be used to display images on a clear transparent medium that establishes the display. Micro-display imaging techniques may also be used.

The user device 50, in addition to presenting demanded images on the transparent display 58, may include a native visual display 62 such as a liquid crystal display (LCD) or light emitting diode (LED) display or other type of display controlled by the processor 52 to present demanded images. The native display 62 may be a touch screen display. In addition, one or more input devices 64 may be provided for inputting user commands to the processor 52. Example input devices include keypads and keyboards, point-and-click devices, a microphone inputting voice commands to a voice recognition engine executed by the processor 52, etc.

One or more microphones 66 may receive user voice signals and provide signals to the processor 52, and in turn the processor 52 can output audible signals representing another party's voice to one or more audio speakers 68. The microphones 66 may be a microphone array and digital signal processing may be effected by the processors herein to produce on the respective speakers 68 a wide field aural effect to enhance the feeling of being in the same room with a remote conversation partner.

A video camera 70 of the user device 50 may be steered under the influence of the processor 52 to track a local user's voice and/or face as imaged by the camera 70 to maintain the local user in the field of view of the camera 70 should the local user move during a conversation. Thus, the video camera 70 may be movably mounted on the user device 50 and moved under control of the processor 52 using, e.g., small servo motors or other assemblies. Preferably the camera 70 is high resolution.

The user device 50 may communicate with a remote second user device 72, labeled “caller B device” in FIG. 2, to conduct a teleconference between two or more people, one (“caller A”) using the first device 50 and the other (“caller B”) using the second device 72. The communication may occur over a link 74 through respective wired or wireless communication interfaces 76, 78. The interfaces 76, 78 may be WiFi transceivers, wireless modems, wireless telephony transceivers, etc. controlled by their respective processors to exchange image and voice information over the link. Thus, the teleconference link 74 may be a wired or wireless telephone link and/or a wired or wireless Internet link.

In the example shown, the second user device 72 includes components similar to those shown for the first device 50, although the two devices need not be identical. Accordingly, for description purposes, a second user device processor 80 accesses a computer readable storage medium 82 that contains instructions which when executed by the processor configure the processor to undertake principles disclosed below. The user device 72 may communicate with other devices using a near field communication (NFC) interface 84. The NFC interface 84 may be a wireless short range communication interface such as but not limited to a Bluetooth transceiver controlled by the processor 80. Radiofrequency identification (RFID) can also be used, without limitation. In the example shown, the second user device 72 communicates with a relatively large but still portable thin transparent display 86. In an example, demanded images from the user device 72 may be presented on the display 86 by means of a projector 88 of the display 86, which projects images onto the display 86.

The second user device 72, in addition to presenting demanded images on the transparent display 86, may include a native visual display 90 such as a liquid crystal display (LCD) or light emitting diode (LED) display or other type of display controlled by the processor 80 to present demanded images. The native display 90 may be a touch screen display. In addition, one or more input devices 92 may be provided for inputting user commands to the processor 80. Example input devices include keypads and keyboards, point-and-click devices, a microphone inputting voice commands to a voice recognition engine executed by the processor 80, etc.

One or more microphones 94 may receive user voice signals and provide signals to the processor 80, and in turn the processor 80 can output audible signals representing another party's voice to one or more audio speakers 96. The microphones 94 may be a microphone array and digital signal processing may be effected by the processors herein to produce on the respective speakers 96 a wide field aural effect to enhance the feeling of being in the same room with a remote conversation partner.

A video camera 98 of the second user device 72 may be steered under the influence of the processor 80 to track a local user's voice and/or face as imaged by the camera 98 to maintain the local user in the field of view of the camera 98 should the local user move during a conversation. Thus, the video camera 98 may be movably mounted on the second user device 72 and moved under control of the processor 80 using, e.g., small servo motors or other assemblies. Preferably the camera 98 is high resolution.

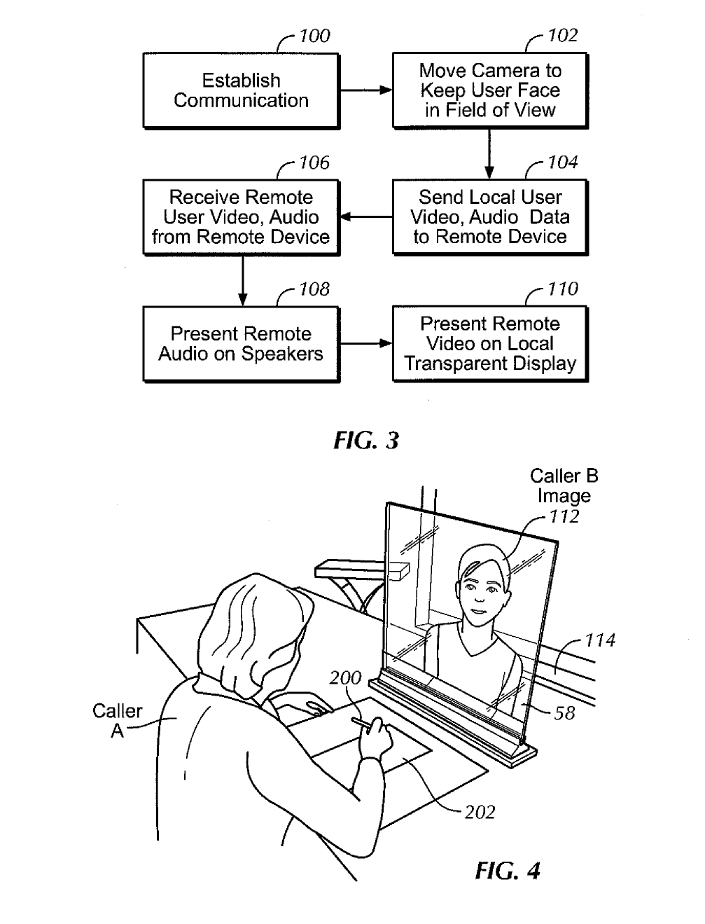

With the description above in mind, refer now to FIG. 3, showing the overall logic that may be followed by each of the user devices 50, 72 during a teleconference session. Communication between the first and second user devices 50, 72 is established over the link 74 at block 100. At block 102 the local device camera is moved as required to maintain the local user in the field of view of the camera. This may be accomplished using face recognition, with the respective processor moving the respective camera as needed to maintain the face of the local user in, for example, the center of the field of view of the camera. When multiple local users are present, the processor may default to keeping the image of the closest (largest) face in view.

Note that in addition to using face recognition to move the cameras, the system may also employ face identification to attach names to recognized faces in the field of view and, if desired, generate an automatic record of participants' names. This would apply principally for business use. In other words, recognized faces may be used as entering arguments for a database lookup to find names matching the faces, and those names may be displayed by superimposing them on or underneath the corresponding images presented on the display.

At block 104, each device sends to its remote partner over the link 74 audio and video information collected by the processor's local camera and microphones. At block 106 each device in turn receives from the other device images and audio of the remote caller. The remote audio received on the link 74 is presented on the local speakers of the receiving device, while the remote video of the remote caller is sent over the NFC interface to the local transparent display (58 or 86) for presentation thereon.

As shown in cross-reference to FIGS. 2 and 4, the result of the above description is that the user of the first device 50 (labeled “caller A” in FIG. 4) can view on the local transparent display 58 an image 112 of the user of the second device 72, this user being labeled as “caller B” in FIG. 4. As shown, the thin transparent display 58 is positioned upright and the local background objects 114 behind the image 112 of the remote user on the display 58 can be seen by the local user (caller A), making the teleconference more realistic as though the remote user (caller B) were actually present in the same room as the local user (caller A). The image 112 of the remote user is substantially life size, around 60%-120% of the size of the actual remote user and more preferably 80%-110% of the size of the actual remote user and more preferably still around 90%-100% of the size of the actual remote user.

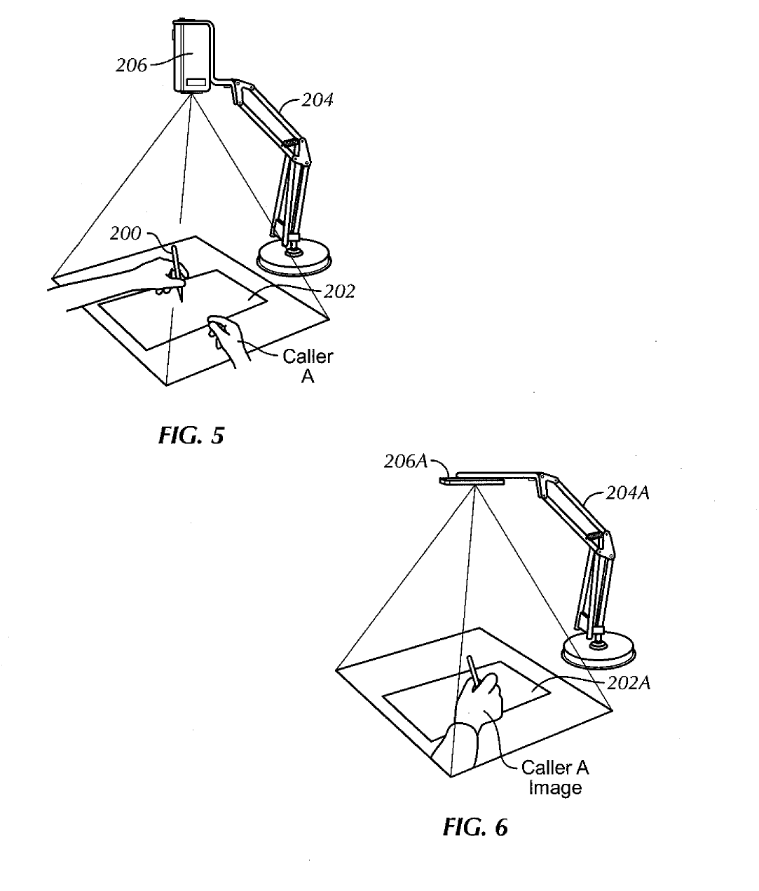

In addition to the above, as shown in FIG. 4 and now also referring to FIGS. 5 and 6, “caller A” may use a digital stylus 200 to write on a substrate 202 to share documents with “caller B” as follows. As best shown in FIG. 5, an articulating movable desklamp armature 204 can hold a device 206 that may be similar to any of the computing devices disclosed herein and that includes an imaging device to image writing on the substrate 202 as well as a projector to project images onto the desk on which the substrate 202 is placed or onto the substrate 202 itself. When “caller A” writes on the substrate 202, the device 206 images the writing and sends the image to a similar device 206A (FIG. 6) on a movable armature 204A at the location of “caller B”. Thus, the devices 206, 206A in FIGS. 5 and 6 are analogous to the devices 50, 72 shown in FIG. 4 with the addition of built-in projector capability. The “caller B” device 206 projects an image 202A of the substrate 202 onto the desk of “caller B” along with an image of the part of “caller A” that is captured by the imaging device on the caller “A” device 206, as received by the caller B device 206A. It is to be understood that caller likewise can write on a substrate at his location and send images of the writing to caller A to enable caller A to view the writing of caller B on the desk of caller A.

In this way, not only may the two callers share upright facial images of each other with local background visible by virtue of the transparent displays 58, 86, they may also share documents on a desk with each other. “Caller A” can write on remotely with the virtual pen that adds it to the projected image on caller B's desk while it is also projected on the back on the original while maintaining position when the original document is moved.

Thus, as described each side (caller A and caller B) needs a camera and a projector capable of high frame rate to capture and display every other frame to avoid the feed back loop. The user devices may employ compositing capability to remove the background and only project the objects or virtual written words. Also, object tracking can be used to follow the objects as they move or rotate and maintain the virtual written words. To this end, processors may control small motors mounted on the armatures 204, 204A to move the imaging devices 206, 206A accordingly.

While the particular PORTABLE TRANSPARENT DISPLAY WITH LIFE-SIZE IMAGE FOR TELECONFERENCE is herein shown and described in detail, it is to be understood that the subject matter which is encompassed by the present invention is limited only by the claims.

What is claimed is:

1. Assembly comprising:
processor; and
video display configured to be controlled by the processor to present on the video display a demanded image of a person participating in a telephone call, wherein the video display is transparent when no image is presented thereon.

2. The assembly of claim 1, wherein the demanded image is of a portion of the person participating in the telephone call, and the demanded image is substantially the same size as the portion of the person.

3. The assembly of claim 2, wherein the demanded image is 60%-120% of the size of the portion of the person.

4. The assembly of claim 2, wherein the demanded image is 80%-110% of the size of the portion of the person.

5. The assembly of claim 2, wherein the demanded image is 90%400% of the size of the portion of the person.

6. The assembly of claim 1, wherein because the display is transparent, local background objects that surround the demanded image can be viewed through the display just as they would be if the person were present locally.

7. The assembly of claim 1, wherein the demanded image is projected onto the display.

8. The assembly of claim 1, wherein the processor is in a user device having a native display controlled by the processor in addition to the video display that is transparent.

9. Assembly, comprising:
communication interface receiving video signals from a remote participant of a teleconference; and
a transparent video display presenting demanded images of the remote participant based on the video signals, local background objects behind the display being visible to a local teleconference participant through the display just as the background objects would be if the remote participant were present locally with the local participant.

10. The assembly of claim 9, wherein the demanded images are of a portion of the remote participant, and the demanded image is substantially the same size as the portion of the remote participant.

11. The assembly of claim 10, wherein the demanded images are 60%420% of the size of the portion of the remote participant.

12. The assembly of claim 10, wherein the demanded images are 80%410% of the size of the portion of the remote participant.

13. The assembly of claim 10, wherein the demanded images are 90%-100% of the size of the portion of the remote participant.

14. The assembly of claim 9, wherein the demanded images are projected onto the display.

15. The assembly of claim 9, wherein a user device having a native display control controls the transparent video display.

16. Method comprising:
establishing a teleconference link with a remote teleconference participant;
receiving demanded images of the remote teleconference participant; and
presenting on a transparent video display the demanded images.

17. The method of claim 16, wherein the demanded images are substantially the same size as the portion of the remote participant which establishes the demanded images.

18. The method of claim 17, wherein the demanded images are 60%-120% of the size of the portion of the remote participant.

19. The method of claim 17, wherein the demanded images are 80%-110% of the size of the portion of the remote participant.

20. The method of claim 17, wherein the demanded images are 90%-100% of the size of the portion of the remote participant.
